(19) United States
(12) Patent Application Publication
(10) Pub. No.: US 2018/0314817 A1
(43) Pub. Date: Nov. 1, 2018

(54) BIOMETRIC-BASED SINGLE SIGN-ON

(71) Applicant: Accenture Global Solutions Limited, Dublin (IE)

(72) Inventors: Vittal Babu GADDE, Bangalore (IN); Sumit DAYAL, Bangalore (IN); Sivavardhan VANGALA, Bangalore (IN); Renjith PARRAKKOTT, Bangalore (IN); Raghavendra LINGAPPA, Alpharetta, GA (US); Santosh Kumar NARAYAN, Bangalore (IN)

(21) Appl. No.: 15/963,895

(22) Filed: Apr. 26, 2018

(30) Foreign Application Priority Data
Apr. 27, 2017 (IN) 201741015015

(51) Int. Cl. G06F 21/41; G06F 21/32; G06F 21/62; G06F 21/60

(52) U.S. Cl. CPC G06F 21/41; G06F 21/32; H04W 12/08; G06F 21/604; G06F 21/6218

(57) ABSTRACT

A device may receive an input from a user to access an application of a plurality of applications on the device. The device may determine whether authentication information, associated with the user and stored on the device, is valid. The device may attempt to verify biometric information associated with the user based on determining that the authentication information is not valid. The biometric information may be provided as input to the device. The device may validate the authentication information based on being able to verify the biometric information. The device may provide the validated authentication information to the application to grant the user access to the plurality of applications on the device.

### RELATED APPLICATION

This application claims priority under 35 U.S.C. § 119 to Indian Patent Application No. 201741015015, filed on Apr. 27, 2017, the content of which is incorporated by reference herein in its entirety.

### BACKGROUND

Single sign-on (SSO) is an authentication process that allows a user to access multiple applications with one set of login credentials. In an SSO process, a user may log in with a single identification and password to gain access to a connected system or systems without using different usernames or passwords. SSO is a common procedure in enterprises, where a client may access multiple resources connected to a local area network.

### SUMMARY

According to some possible implementations, a device may include one or more memories; and one or more processors, communicatively coupled to the one or more memories, to receive an input from a user to access an application of a plurality of applications on the device. The one or more processors may determine whether authentication information, associated with the user and stored on the device, is valid. The one or more processors may attempt to verify biometric information associated with the user based on determining that the authentication information is not valid. The biometric information may be provided as input to the device. The one or more processors may validate the authentication information based on being able to verify the biometric information. The one or more processors may provide the validated authentication information to the application to grant the user access to the plurality of applications on the device.

According to some possible implementations, a method may include receiving, by a device, an input from a user to access an application of a plurality of applications on the device. The method may include determining, by the device and based on receiving the input, whether there is valid authentication information, associated with the user, stored in a secure data store on the device. If the authentication information is determined to be valid, the method may include providing, by the device, the authentication information to the application to grant the user access to the plurality of applications on the device. If the authentication information is determined to be not valid, the method may include providing, by the device, a request for the user to provide biometric information associated with the user as input to the device, attempting, by the device, to verify biometric information, associated with the user, received based on providing the request, validating, by the device, the authentication information based on being able to verify the biometric information, and providing, by the device, the validated authentication information to the application to grant the user access to the plurality of applications on the device.

According to some possible implementations, a non-transitory computer-readable medium may store one or more instructions that, when executed by one or more processors, cause the one or more processors to receive an input from a user to access an application of a plurality of applications on a device. The one or more instructions, when executed by the one or more processors, may cause the one or more processors to identify, based on receiving the input, a validity status of authentication information, associated with the user, stored in a secure data store on the device. The validity status of the authentication information may be based on a time duration of inactivity associated with the plurality of applications. The validity status of the authentication information may be stored in a SSO data store on the device. The one or more instructions, when executed by the one or more processors, may cause the one or more processors to attempt to verify biometric information associated with the user based on the validity status of authentication information being identified as not valid. The biometric information may be provided as input to the device. The one or more instructions, when executed by the one or more processors, may cause the one or more processors to validate the authentication information based on being able to verify the biometric information. The one or more instructions, when executed by the one or more processors, may cause the one or more processors to provide the validated authentication information to the application to grant the user access to the plurality of applications on the device.

### BRIEF DESCRIPTION OF THE DRAWINGS

FIGS. 1A-1H are diagrams of an overview of an example implementation described herein.

FIG. 2 is a diagram of an example environment in which systems and/or methods, described herein, may be implemented.

FIG. 3 is a diagram of example components of one or more devices of FIG. 2.

FIG. 4 is a flow chart of an example process for biometric-based SSO.

FIG. 5 is a flow chart of an example process for biometric-based SSO.

FIG. 6 is a flow chart of an example process for biometric-based SSO.

### DETAILED DESCRIPTION

The following detailed description of example implementations refers to the accompanying drawings. The same reference numbers in different drawings may identify the same or similar elements.

Devices, and applications available thereon, may be secured using various authentication techniques. Some techniques involve users signing on to (or authenticating) applications using login credentials, such as a username and password or a passcode. These techniques may be insecure because unintended users may be able to obtain the login credentials and gain access to the applications without authorization. Moreover, these techniques may be inefficient because users may have to enter respective login credentials for each individual application.

Some implementations, described herein, provide a device that has biometric-based security on the device at the application level. The device may be configured with a single sign-on capability that prompts a user to provide biometric information instead of, or in addition to, other login credentials. In this way, the security of the device is increased by the use of biometric information to limit access to the applications to certain users. Moreover, the client device can provide users with broad access to a plurality of applications available on the device via a single biometric-based authentication. This decreases device resource usage during the authentication process by reducing duplicative authentication steps. In addition, this decreases application deployment times by allowing the user to authenticate through one application, and rapidly deploy other applications without having to re-authenticate.

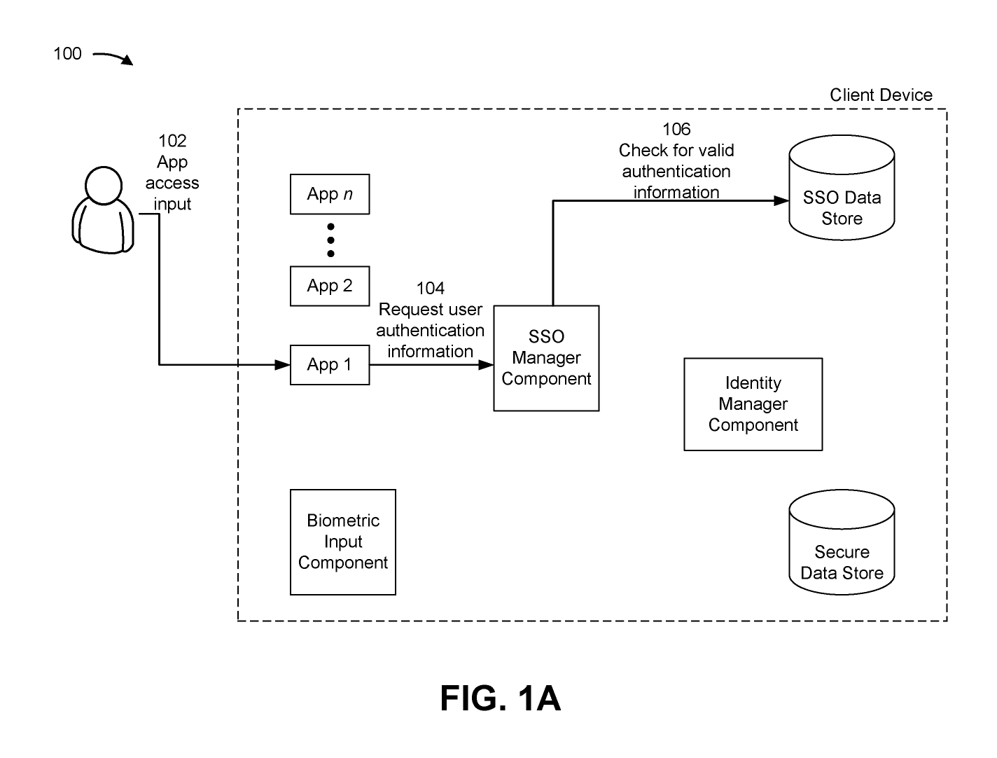

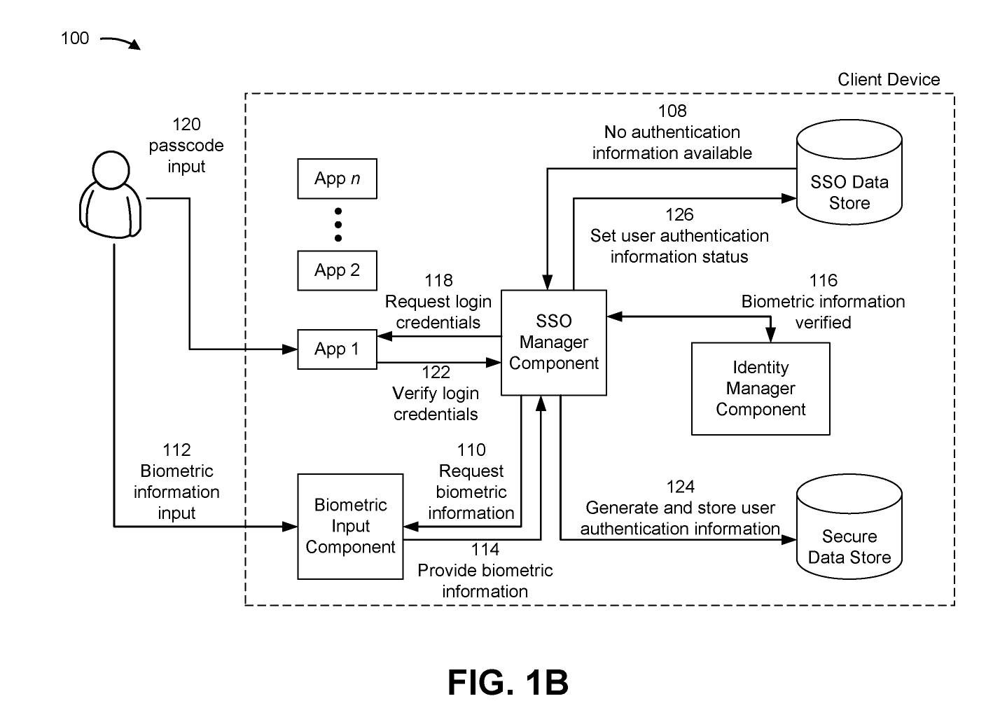

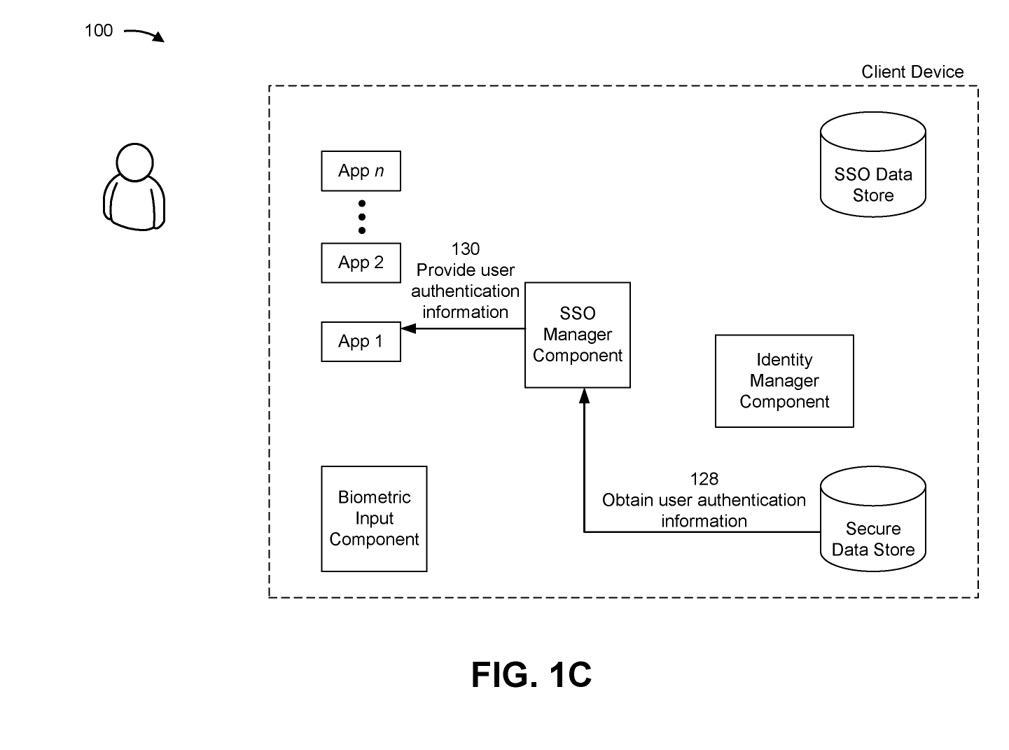

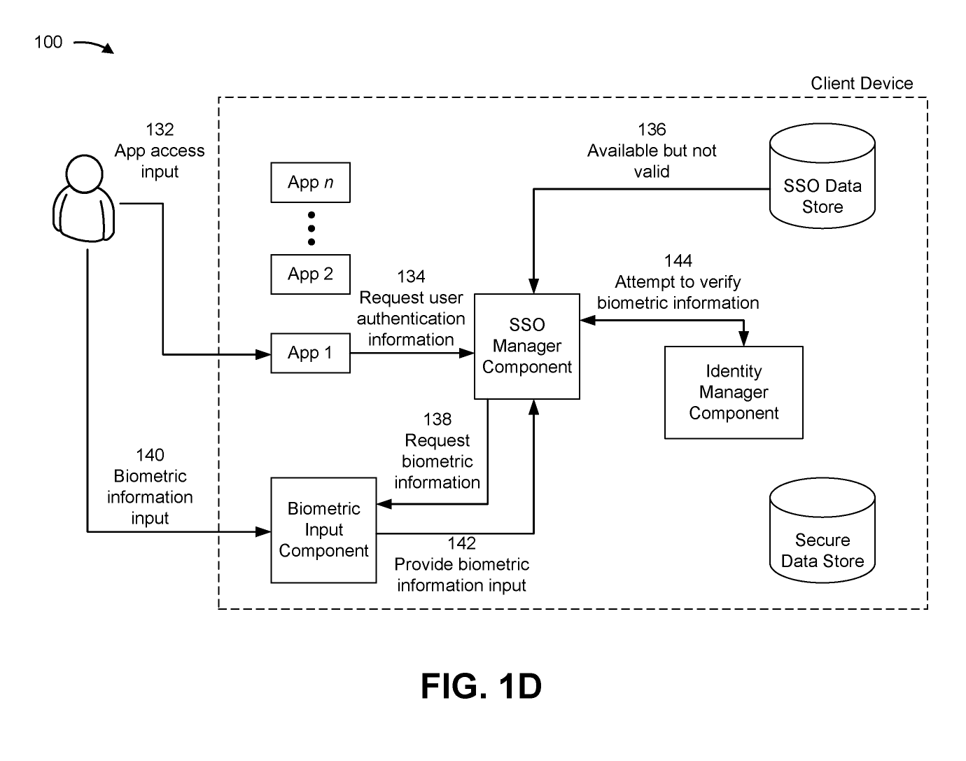

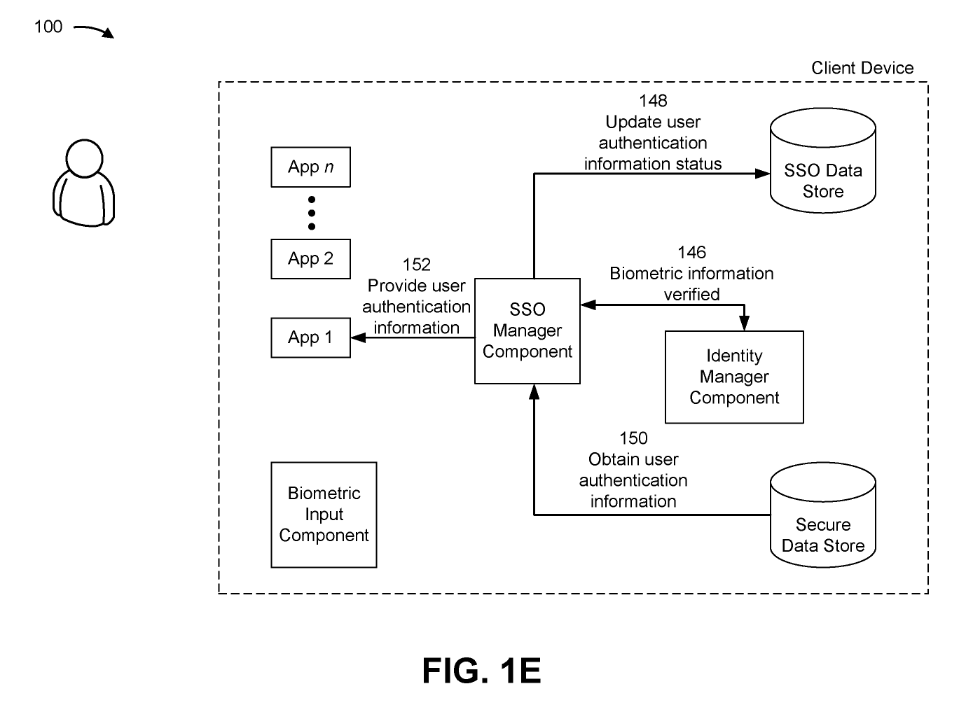

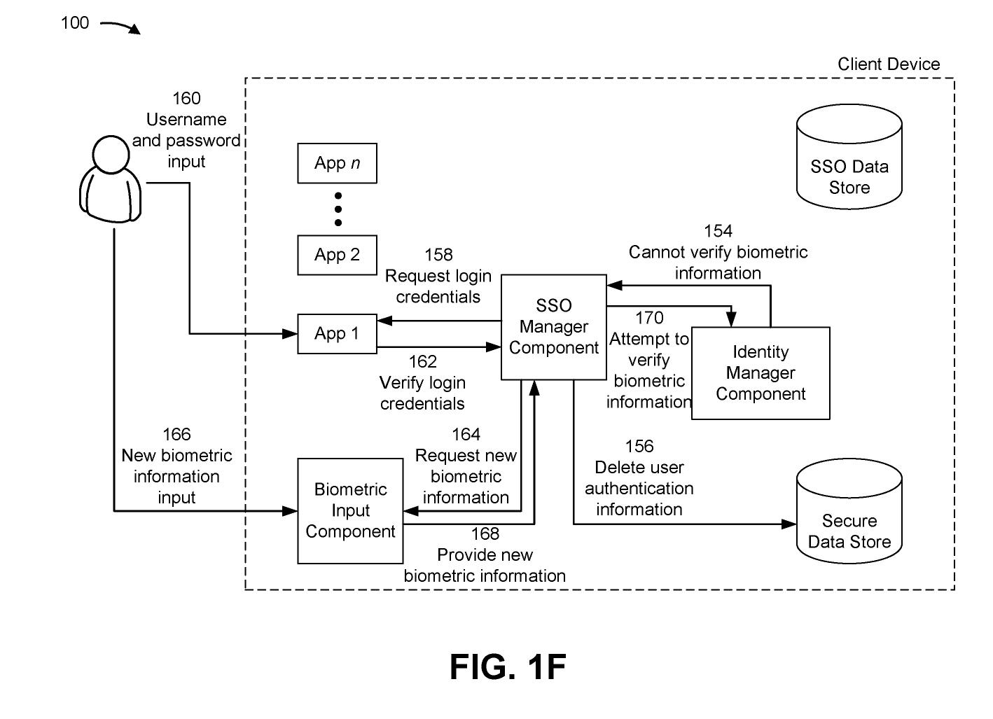

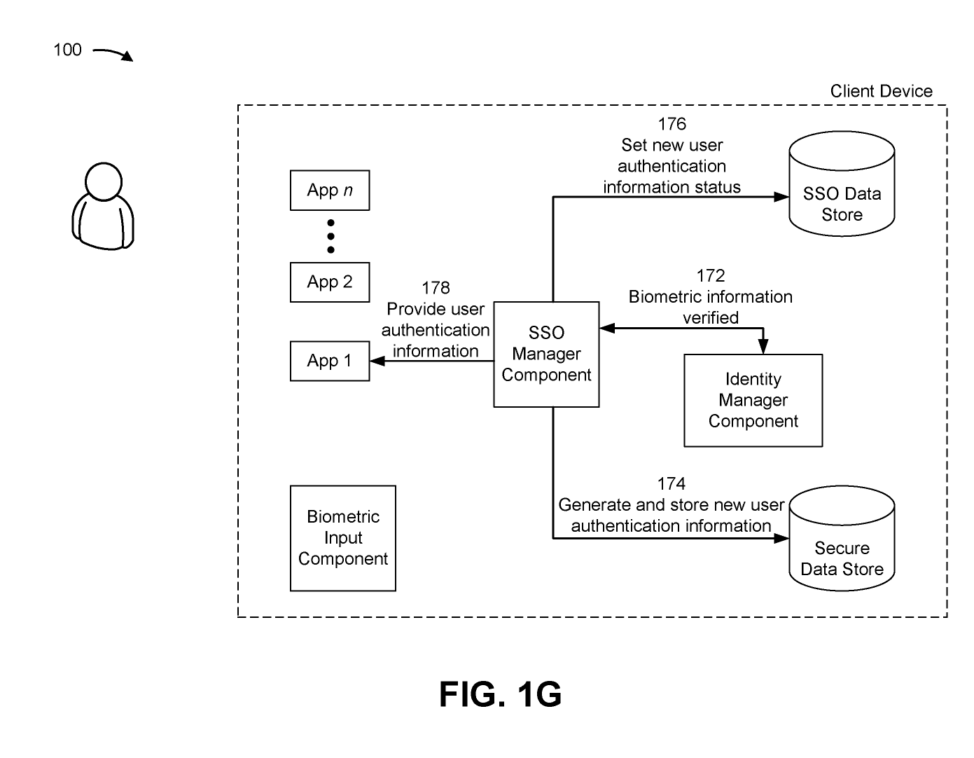

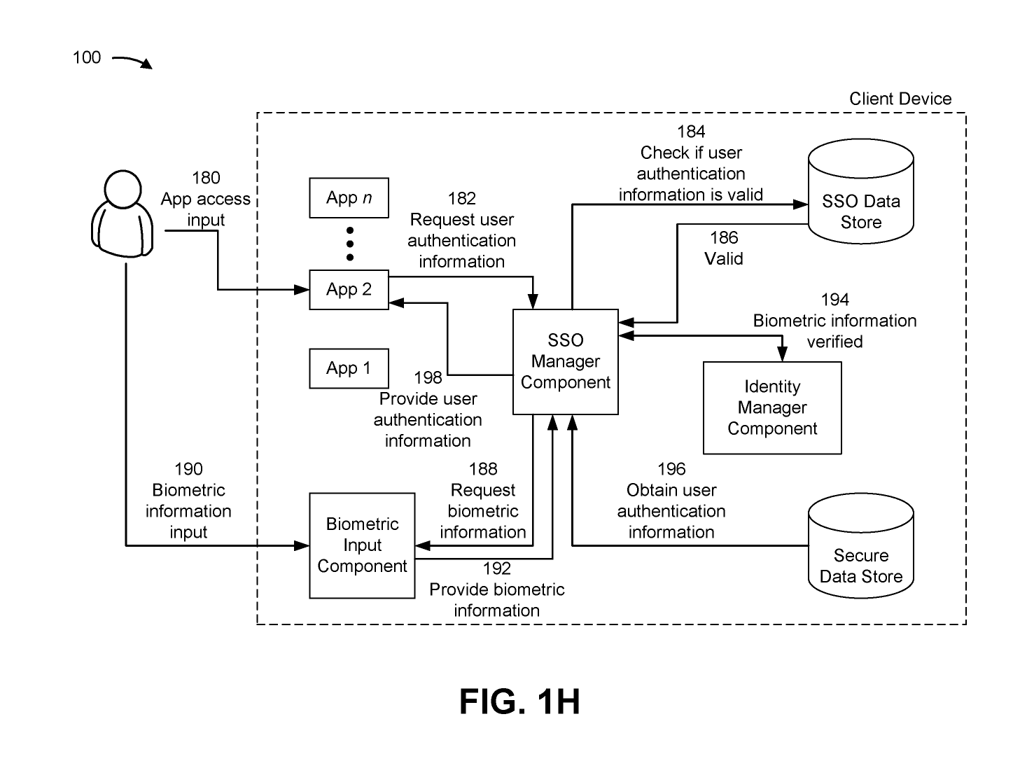

FIGS. 1A-1H are diagrams of an overview of an example implementation 100 described herein. As shown in FIGS. 1A-1H, example implementation 100 may include a client device that contains a plurality of applications (shown as App 1 through App n), an SSO manager component, an SSO data store, an identity manager component, a secure data store, and a biometric input component.

The client device may be a laptop computer, a tablet computer, a handheld computer, a mobile phone such as smartphone, and/or the like. The client device may be deployable in various contexts, such as a retail store, an enterprise office setting, a customer service center, a field service management setting, a restaurant, a coffee shop, and/or the like. As an example, the client device may be a tablet computer deployed in a retail store as a point of sale (PoS) device.

The plurality of applications on the client device may include various types of applications, such as a PoS application, an inventory tracking application, an issue tracking application, a customer database application, a field service tracking application, and/or the like.

User access for the plurality of applications may be managed by the SSO manager component. The SSO manager component may be communicatively connected to the applications, and may generally provide single sign-on functionality for the plurality of applications. The SSO functionality may allow a user to provide biometric information associated with the user, and may provide the user with access to the plurality of applications on the client device based on being able to verify the biometric information associated with the user. Biometric information associated with the user may include any biological trait that identifies the user, such as a fingerprint, hand geometry, retina or iris pattern, voice signature, facial pattern, and/or the like.

To verify biometric information associated with the user, the SSO manager component may use the biometric input component to obtain the biometric information associated with the user. For example, the SSO manager component may obtain the user's biometric information as input to the biometric input component. The biometric input component may include various types of input devices and/or interfaces that allow the user to input biometric information. Examples of biometric input components include a fingerprint or hand scanner, an eye scanner, a facial scanner, a voice recorder, and/or the like.

With the biometric information associated with the user obtained via the biometric input component, the SSO manager component may attempt to verify the obtained biometric information, associated with the user, by comparing the obtained biometric information and reference biometric information, associated with the user, stored in the identity management component. Reference biometric information may be biometric information a user provided to the client device when establishing a biometric authentication profile on the client device, similar to when generating a username and password for an authentication profile. The user's reference biometric information serves as a way (similar to a username and password) for the SSO manager component to verify the user's identity.

The identity manager component may include an encrypted data store that stores the reference biometric information associated with the user in an encrypted manner so that the reference biometric information associated with the user is secured from tampering and/or unauthorized access. The identity manager component may also include a processor that receives the obtained biometric information associated with the user and compares the obtained biometric information and the reference biometric information associated with the user. The obtained biometric information associated with the user may be successfully verified if the obtained biometric information matches the reference biometric information associated with the user. In some implementations, the processor of the identity manager component may also encrypt the obtained biometric information associated with the user. In some implementations, instead of the processor of the identity manager component performing the comparison, the processor of the identity manager component may decrypt the reference biometric information associated with the user, provide it to the SSO manager component, and the SSO manager component may compare the biometric information associated with the user and the reference biometric information associated with the user.

The secure data store may be communicatively connected to the SSO manager component and may store authentication information, such as tokens, cookies, and/or the like, associated with the user. In some instances, the SSO manager component may obtain and provide the authentication information, associated with the user and stored in the secure data store, to the plurality of applications on the client device to grant the user access to the plurality of applications. The plurality of applications on the client device may grant access to the user by providing the authentication information associated with the user to their respective back-end application servers.

In some implementations, the secure data store may be locked to provide security for the authentication information stored therein. The SSO manager component may unlock the secure data store by obtaining biometric information associated with the user and verifying the biometric information as described above. With the secure data store unlocked, the SSO manager component may obtain the authentication information associated with the user and provide the authentication information to one or more applications, of the plurality of applications, to grant the user access to the one or more applications.

The SSO data store may be communicatively connected to the SSO manager component, and may store metadata associated with the authentication information, associated with the user, stored in the secure data store. As an example, the metadata may include information identifying a time the authentication information was generated, information identifying a time the authentication information was last accessed by the SSO manager component, a validity status of the authentication information (i.e., as a status indicating whether the authentication information is valid or invalid), and/or the like.

In some implementations, the SSO manager component may maintain the validity status of the authentication information based on whether the user logs out of one or more of the of the plurality of applications. For example, if the user logs out of one or more of the plurality of applications, the SSO manager component may set the validity status of the authentication information to not valid.

In some implementations, the SSO manager component may maintain the validity status of the authentication information based on a time duration of inactivity associated with each respective application of the plurality of applications on the client device (i.e., App 1 may have its own time duration of inactivity, App 2 may have its own time duration of inactivity, and so on). In some implementations, a time duration of inactivity associated with a respective application may be based on an amount of time the respective application is minimized, closed, and/or running in a background of the client device's operating system (OS). For example, App 1 may be launched and running on the client device, but the user may be interacting with App 2, and thus App 1 may be minimized, closed, and/or running in the background of the client device's OS while the user is interacting with App 2 in the foreground of the client device's OS. The amount of time App 1 is minimized, closed, and/or running in the background of the client device's OS may be App 1's time duration of inactivity. In some implementations, a time duration of inactivity associated with a respective application may be based on an amount of time the respective application is in the foreground of the client device's OS, but sitting idle because the user is not interacting with the respective application. For example, App 1 may be launched and running on the client device in the foreground of the client device's OS, but the user has not interacted with App 1 for an amount of time. The amount of time App 1 is launched and running on the client device in the foreground of the client device's OS without the user interacting with App 1 may be App 1's time duration of inactivity.

The SSO manager component may maintain a threshold time duration of inactivity (e.g., 15 minutes, 30 minutes, etc.) and may compare the time duration of inactivity associated with each respective application of the plurality of applications on the client device and the threshold time duration of inactivity. The SSO manager component may set the validity status of the authentication information based on the result of the comparison. For example, if any of the plurality of applications on the client device has an associated time duration of inactivity that does not satisfy the threshold time duration of inactivity (e.g., none of the plurality of applications on the client device has been inactive for 30 minutes or more), then the SSO manager component may set the validity status of the authentication information to valid, which indicates that the authentication information may be used to grant the user access to the plurality of applications on the client device. As another example, if an application, of the plurality of applications on the client device, has an associated time duration of inactivity that satisfies the threshold time duration of inactivity (e.g., the application has been inactive for 30 minutes or more), then the SSO manager component may set the validity status of the authentication information to not valid, which indicates that the authentication information may not be used to grant the user access to the plurality of applications on the client device until the authentication is validated again.

Turning now to FIG. 1A, in some implementations, a user of the client device may desire to access one or more of the plurality of applications on the client device. For example, when the client device is deployed in a customer service center, the user (a customer service representative in this example) may be handling a service call from a customer pertaining to a trouble ticket, and thus may desire to access a customer database application and/or an issue tracking application on the client device. Accordingly, as shown by reference number 102, the user may request access to an application (e.g., App 1) by providing an input, such as an input via a user interface of the client device (e.g., by pressing an application icon, by using a voice command, and/or the like).

The application may launch (or start executing) on the client device based on receiving the input from the user, but may not yet provide the user with access to the application because the application may need authentication information associated with the user before the application can grant access. Thus, as shown by reference number 104, the application may generate a request for authentication information associated with the user, and may provide the request to the SSO manager component.

As shown by reference number 106, the SSO manager component may access the SSO data store to determine whether there is valid authentication information, associated with the user, stored in the secure data store. For example, the SSO manager component may reference metadata in the SSO data store to determine whether there is valid authentication information, associated with the user, stored in the secure data store. If authentication information has been previously generated for the user, the metadata in the SSO data store may include information about the authentication information, such as a time when the authentication information was generated, a time when the SSO manager component last accessed the authentication information, a validity status of the authentication information, and/or the like.

As shown in FIG. 1B, and by reference number 108, in some cases, the SSO manager component may determine that no authentication information associated with the user is available in the secure data store. For example, the SSO manager component may determine that no authentication information associated with the user is available in the secure data store by determining that there is no metadata available in the SSO data store. This may occur in some situations, such as when the user logs on to the client device for the first time (e.g., the first time the user logs on to the client device during a particular day, during a shift of the user, after rebooting the client device, etc.). If this occurs, the SSO management component may perform a process, illustrated by reference numbers 110-126, to establish authentication information associated with the user so that the authentication information associated with the user may be used to grant the user access to the plurality of applications on the client device.

In some implementations, a device management platform may configure the client device by enabling various types of authentication techniques the SSO manager can use to establish the authentication information. For example, the device management platform may configure the use of biometric information verification, whereas in some implementations, the device management platform may allow other techniques to be used. In some implementations, the device management platform may configure the client device with different types of authentication techniques for different applications. For example, the device management platform may configure the client device to use biometric verification information for enterprise applications on the client device, and may allow another other types of applications to use another type of authentication technique.

Accordingly, the SSO manager component may determine that the client device has been configured by the device management platform to use biometric information validation, and may establish authentication information associated with the user by attempting to verify biometric information associated with the user based on determining that the device is configured by the device management platform to use biometric information validation. As shown by reference number 110, the SSO manager component may provide a request to the biometric input component to obtain biometric information associated with the user to establish authentication information associated with the user. The request may be a request for the user to provide a fingerprint or hand scan, a retina or iris scan, a facial scan, a voice input, and/or the like. As shown by reference number 112, the user may provide biometric information associated with the user as input to the biometric input component. As shown by reference number 114, the biometric input component may provide the biometric information associated with the user to the SSO manager component.

As shown by reference number 116, the SSO manager component may attempt to verify the biometric information associated with the user. The SSO manager component may attempt to verify the biometric information associated with the user by providing the biometric information associated with the user to the identity manager component, where the identity manager component compares the biometric information associated with the user and reference biometric information, associated with the user, stored in the identity manager component. Verification of the biometric information associated with the user may be successful if the comparison results in a match between the biometric information associated with the user and the reference biometric information associated with the user. Examples of a match include a fingerprint scan provided by the user matching a reference fingerprint scan for the user, a geometry of a hand scan provided by the user matching a geometry of a reference hand scan for the user, an iris or retina scan provided by the user matching a reference iris or retina scan for the user, a facial scan provided by the user matching a reference facial scan for the user, a sound signature of a voice recording provided by the user matching a reference voice signature for the user, and/or the like. In some implementations, a match may be defined as a 100% match (i.e., an exact match) between the biometric information associated with the user and the reference biometric information associated with the user. In some implementations, a match may be defined by a threshold, such as a 98% match, a 90% match, an 85% match, and/or the like. As an example, the biometric information associated with the user and the reference biometric information associated with the user may be a match if there is a 95% match between the biometric information associated with the user and the reference biometric information associated with the user.

As further shown in FIG. 1B, and as shown by reference number 118, if the SSO manager component successfully verifies the biometric information associated with the user, the SSO manager component may request login credentials, such as a username and password or a passcode, via the application (i.e., App 1). In this way, the combination of verifying biometric information associated with the user and the user-provided login credentials provides additional security (in the form of two-factor authentication) when the user signs on for the first time. As shown by reference number 120, the user of the client device may input the login credentials and, as shown by reference number 122, the application (i.e., App 1) may provide the login credentials to the SSO manager component so that the SSO manager component may attempt to verify the login credentials. The SSO manager component may attempt to verify the login credentials by, for example, verifying that the username and password or the passcode provided by the user match a username and password or a passcode stored in a back-end application server associated with the application (i.e., App 1).

As shown by reference number 124, if the SSO manager component can successfully verify the login credentials provided by the user, the SSO manager component may generate authentication information (e.g., a token, a cookie, and/or the like), associated with the user, and store the authentication information in the secure data store. As shown by reference number 126, the SSO manager component may generate metadata for the authentication information associated with the user and store the metadata in the SSO data store. In particular, the SSO manager component may set, in the metadata, a validity status for the authentication information associated with the user to valid.

As shown in FIG. 1C, and by reference number 128, with the authentication information associated with the user validated, the SSO manager component may obtain the validated authentication information from the secure data store and as shown by reference number 130, provide the authentication information associated with the user to the application (i.e., App 1) to grant the user access to the plurality of applications on the client device. In this way, the user is granted access to a plurality of applications using a biometric-based single sign-on. This reduces application access times and reduces the amount of client device resources used for authentication by eliminating repeated authentication steps when the user signs onto the client device for the first time.

In some implementations, at some time after the authentication information associated with the user has been generated, the user may desire to again access an application among the plurality of applications on the client device. In an example scenario, the user may be a retail store clerk coming back from a break, and may request access to a PoS application on the client device. If the authentication information associated with the user has become invalid prior to the user requesting access to the application, the SSO management component may perform a revalidation process to revalidate the authentication information associated with the user.

Turning now to FIG. 1D, and by reference number 132, the user may request access to the application (e.g., App 1) by providing an input, such as an input via the user interface of the client device (e.g., by pressing an application icon, by providing a voice command, and/or the like). The application may launch (or start executing) on the client device based on receiving the input from the user, but may not yet provide the user with access to the application because the application may need authentication information associated with the user before the application can grant access. Thus, as shown by reference number 134, the application may generate a request for authentication information associated with the user, and may provide the request to the SSO manager component.

As shown by reference number 136, the SSO manager component may access the SSO data store to determine whether there is valid authentication information, associated with the user, stored in the secure data store. For example, the SSO manager component may reference metadata in the SSO data store to determine the validity status of the authentication information, associated with the user, stored in the secure data store. In some cases, the SSO manager component may determine that the authentication information associated with the user is available in the secure data store, but is not valid. For example, the SSO manager component may determine that the authentication information, associated with the user, in the secure data store is not valid based on the validity status for the authentication information, associated with the user, indicating that the authentication information, associated with the user, is not valid. This may occur in some situations, such as when the user has not been actively using one or more of the plurality of applications on the client device, when the user has logged out of one or more of the plurality of applications, where the user has closed one or more of the plurality of applications, and/or the like.

As explained above, the SSO manager component may maintain the validity status of the authentication information based on a time duration of inactivity associated with one or more applications of the plurality of applications on the client device, as well as a threshold time duration of inactivity. The SSO manager component may compare the time duration of inactivity and the threshold time duration of inactivity, and set the validity status of the authentication information, associated with the user and stored in the secure data store, and not valid if an application (or each application) of the plurality of applications on the client device has an associated time duration of inactivity that satisfies the threshold time duration of inactivity. If this occurs, the SSO management component may perform a process, illustrated by reference numbers 138-146, to revalidate the authentication information associated with the user so that the authentication information associated with the user may be used to grant the user access to the plurality of applications on the client device.

In some implementations, the device management platform may configure the use of biometric information verification on the client device, whereas in some implementations, the device management platform may allow other techniques to be used. Accordingly, the SSO manager component may determine that the client device has been configured by the device management platform to use biometric information validation, and may revalidate the authentication information associated with the user by attempting to verify biometric information associated with the user based on determining that the device is configured by the device management platform to use biometric information validation.

As shown by reference number 138, the SSO manager component may request biometric information, associated with the user, from the biometric input component based on determining that the authentication information, associated with the user and stored in the secure data store, is not valid. The request may be a request for the user to provide a fingerprint or hand scan, a retina or iris scan, a facial scan, a voice input, and/or the like.

As shown by reference number 140, the user may provide biometric information associated with the user as input to the biometric input component. As shown by reference number 142, the biometric input component may provide the biometric information associated with the user to the SSO manager component.

As shown by reference number 144, the SSO manager component may attempt to verify the biometric information associated with the user. The SSO manager component may attempt to verify the biometric information associated with the user by providing the biometric information associated with the user to the identity manager component, where the identity manager component compares the biometric information associated with the user and reference biometric information, associated with the user, stored in the identity manager component. Verification of the biometric information associated with the user may be successful if the comparison results in a match between the biometric information associated with the user and the reference biometric information associated with the user. Examples of a match are described above.

As shown in FIG. 1E, and by reference number 146, if the SSO manager component successfully verifies the biometric information associated with the user, the SSO manager component may update the validity status of the authentication information, associated with the user and stored in the secure data store, to valid by setting the validity status in the SSO data store to valid.

As shown by reference number 148, with the authentication information associated with the user validated, the SSO manager component may obtain the validated authentication information from the secure data store and, as shown by reference number 150, provide the authentication information associated with the user to the application (i.e., App 1) to grant the user access to the plurality of applications on the client device. In this way, the user is granted access to a plurality of applications using a biometric-based single sign-on. This reduces application access times and reduces the amount of client device resources used on re-authenticating user access to the plurality of applications on the client device by eliminating the need to individually re-authenticate access for each of the plurality of applications.

In some implementations, when attempting to verify the biometric associated with the user at reference number 144 of FIG. 1E, the SSO manager may not be able to verify the biometric information associated with the user, as shown by reference number 154 in FIG. 1F. This may occur when the identity manager component may be unable to match the biometric information associated with the user with the reference biometric information, associated with the user, in the identity manager component. This may happen in various situations, such as in situations where no reference biometric information or inaccurate biometric information is stored by identity manager component, but also in situations where accurate reference biometric information is stored by the identity manager component. For example, the user might provide a fingerprint or hand scan that does not match the reference fingerprint or hand scan for the user in a situation where the user placed their fingerprint in a different orientation compared to the reference fingerprint, where the user's fingerprint is obscured because the fingerprint scanner or the user's finger is dirty, where the user did not leave their finger on the fingerprint scanner long enough for the fingerprint scanner to fully generate a fingerprint scan, and/or the like. Similarly, the user might provide an iris or retina scan that does not match the reference scan of the user's iris or retina in a situation where the user blinked or looked away from the eye scanner when the scan was being captured, and/or the like. In some implementations, the SSO manager component may allow the user multiple unsuccessful attempts to verify their biometric information (e.g., 3 attempts, 5 attempts, etc.) before the SSO manager component determines that the biometric information, associated with the user, cannot be verified. In some implementations, the SSO manager may allow one unsuccessful attempt before determining that the biometric information, associated with the user, cannot be verified.

As shown by reference number 156, if the SSO manager component cannot verify the biometric information associated with the user, the SSO manager component may delete the user authentication information, associated with the user, stored in the secure data store. This may provide enhanced security for the authentication information associated with the user, because one or more unsuccessful attempts to verify the biometric information associated with the user may be an indicator that an unauthorized user is attempting to gain access to the plurality of applications on the client device.

As shown by reference number 158, after deleting the authentication information, associated with the user, in the secure data store, the SSO manager component may request the user to provide login credentials (e.g., a username and password, a passcode, etc.) via the application (i.e., App 1). As shown by reference number 160, the user may input the login credentials and, as shown by reference number 162, the application (i.e., App 1) may provide the login credentials to the SSO manager component so that the SSO manager component may attempt to verify the login credentials. The SSO manager component may attempt to verify the login credentials by, for example, verifying that the username and password or the passcode provided by the user match a username and password or a passcode stored in a back-end application server associated with the application (i.e., App 1).

As shown by reference number 164, if the SSO manager component can successfully verify the login credentials provided by the user, the SSO manager component may provide a request to the biometric input component to obtain new biometric information associated with the user. The request may be a request for the user to provide a fingerprint or hand scan, a retina or iris scan, a facial scan, a voice input, and/or the like. As shown by reference number 166, the user may provide new biometric information associated with the user as input to the biometric input component. As shown by reference number 168, the biometric input component may provide the new biometric information associated with the user to the SSO manager component.

As shown by reference number 170, the SSO manager component may attempt to verify the new biometric information associated with the user. The SSO manager component may attempt to verify the biometric information associated with the user by providing the biometric information associated with the user to the identity manager component, where the identity manager component compares the biometric information associated with the user and reference biometric information, associated with the user, stored in the identity manager component. Verification of the new biometric information associated with the user may be successful if the comparison results in a match between the new biometric information associated with the user and the reference biometric information associated with the user. Examples of a match are described above.

As shown in FIG. 1G, if the SSO manager component can successfully verify the new biometric information associated with the user at reference block 172, the SSO manager component may generate new authentication information (e.g., a token, a cookie, and/or the like), associated with the user, and store the new authentication information in the secure data store at reference block 174. As shown by reference number 176, the SSO manager component may generate metadata for the new authentication information associated with the user and store the metadata in the SSO data store. In particular, the SSO manager component may set, in the metadata, a validity status, for the new authentication information associated with the user, to valid.

With the authentication information associated with the user validated, the SSO manager component may obtain the validated authentication information from the secure data store and, as shown by reference number 178, provide the authentication information associated with the user to the application (i.e., App 1) to grant the user access to the plurality of applications on the client device.

In some implementations, a user may be using an application (e.g., App 1) of the plurality of applications on the client device, and may desire to start using a second application (e.g., App 2) of the plurality of applications on the client device. For example, the user may be a restaurant maître d′ using a reservation booking application, and may desire to switch over to a table management application to assign a table in the restaurant to a party entering the restaurant. Since the user is currently authenticated (i.e., the authentication information associated with the user is valid) and is using one of the plurality of applications on the client device, the single sign-on functionality of the SSO manager component may provide authentication information associated with the user to the second application without having to obtain login credentials (e.g., username and password, passcode, and/or the like) from the user after verifying biometric information associated with the user.

Accordingly, and as shown in FIG. 1H by reference number 180, the user may request access to the second application (i.e., App 2) by providing an input, such as via a user interface of the client device (e.g., by pressing an application icon, using a voice command, and/or the like). The second application may launch (or start executing) on the client device based on receiving the input from the user, but may not yet provide the user with access to the application because the application may need authentication information associated with the user before the application can grant access. Thus, as shown by reference number 182, the application may generate a request for authentication information associated with the user, and may provide the request to the SSO manager component.

As shown by reference number 184, the SSO manager component may access the SSO data store to determine whether there is valid authentication information, associated with the user, stored in the secure data store. For example, the SSO manager component may reference metadata in the SSO data store to determine whether there is valid authentication information, associated with the user, stored in the secure data store. If authentication information has been previously generated for the user, the metadata in the SSO data store may include information about the authentication information, such as information identifying a time when the authentication information was generated, information identifying a time when the SSO manager component last accessed the authentication information, a validity status of the authentication information, and/or the like. In some cases, the SSO manager component may determine that the authentication information associated with the user is available in the secure data store and is valid. For example, and as shown at reference number 186, the SSO manager component may determine that the authentication information, associated with the user, in the secure data store is valid based on the validity status for the authentication information, associated with the user, indicating that the authentication information, associated with the user, is valid. This may occur in some situations, such as when the user has been actively using one or more of the plurality of applications on the client device.

In some implementations, the device management platform may configure the use of biometric information verification on the client device, whereas in some implementations, the device management platform may allow other techniques to be used. Accordingly, the SSO manager component may determine that the client device has been configured by the device management platform to use biometric information validation, and may provide the valid authentication information to the second application after verifying biometric information associated with the user based on determining that the device is configured by the device management platform to use biometric information validation.

As shown at reference number 188, the SSO manager component may request biometric information, associated with the user, from the biometric input component, when the authentication information, associated with the user is determined to be valid. The request may be a request for the user to provide a fingerprint or hand scan, a retina or iris scan, a facial scan, a voice input, and/or the like. As shown by reference number 190, the user may provide biometric information associated with the user as input to the biometric input component. As shown by reference number 192, the biometric input component may provide the biometric information associated with the user to the SSO manager component.

As shown by reference number 194, the SSO manager component may attempt to verify the biometric information associated with the user. The SSO manager component may attempt to verify the biometric information associated with the user by providing the biometric information associated with the user to the identity manager component, where the identity manager component compares the biometric information associated with the user and reference biometric information, associated with the user, stored in the identity manager component. Verification of the biometric information associated with the user may be successful if the comparison results in a match between the biometric information associated with the user and the reference biometric information associated with the user. Examples of a match are described above.

As shown by reference number 196, the SSO management component may obtain the verified authentication information, associated with the user, from the secure data store based on being able to verify the biometric information associated with the user. As shown by reference number 198, the SSO management component may provide the verified authentication information associated with the user to the second application (i.e., App 2) to grant the user access to the plurality of applications on the client device.

As indicated above, FIGS. 1A-1H are provided merely as examples. Other examples are possible and may differ from what was described with regard to FIGS. 1A-1H.

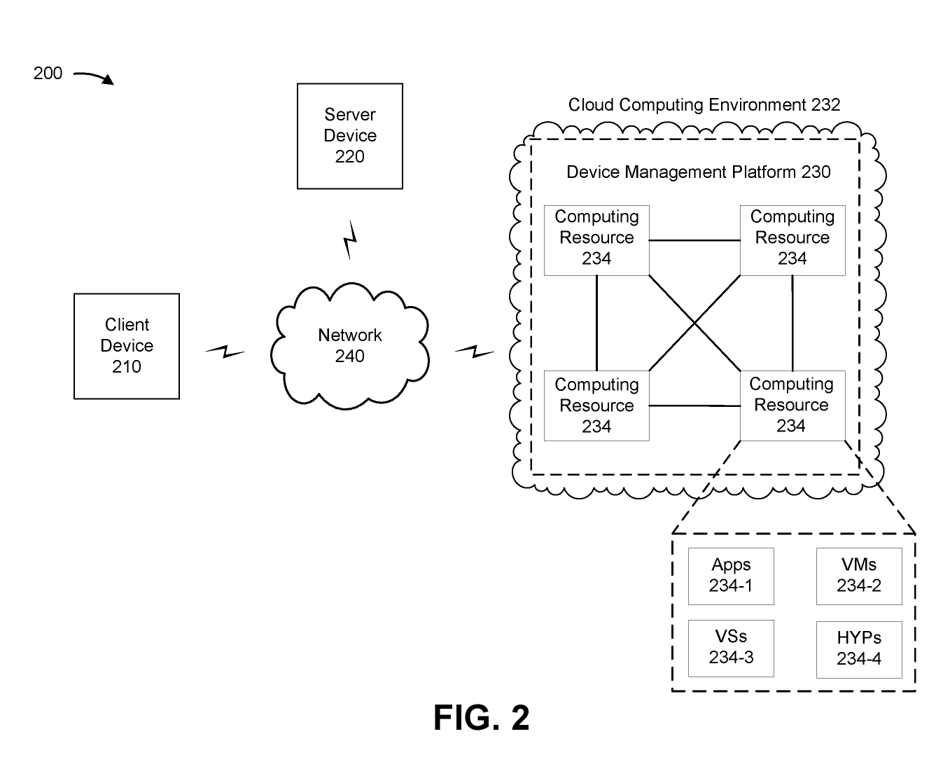

FIG. 2 is a diagram of an example environment 200 in which systems and/or methods, described herein, may be implemented. As shown in FIG. 2, environment 200 may include a client device 210, a server device 220, a device management platform 230 in a cloud computing environment 232 that includes a set of computing resources 234, and a network 240. Devices of environment 200 may interconnect via wired connections, wireless connections, or a combination of wired and wireless connections.

Client device 210 includes one or more devices capable of receiving, generating, storing, processing, and/or providing information associated with aspects of an organization to be analyzed. For example, client device 210 may include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), a desktop computer, or a similar type of device.

Server device 220 includes one or more devices capable of receiving, generating storing, processing, and/or providing information associated with the applications on client device 210. For example, server device 220 may include a back-end application server, which may communicate with the applications on client device 210 to obtain authentication information (e.g., token(s), cookie(s), etc.) to provide users with access to the applications on client device 210. In some implementations, server device 220 may include a server (e.g., in a data center or a cloud computing environment), a data center (e.g., a multi-server micro datacenter), a workstation computer, a virtual machine (VM) provided in a cloud computing environment, or a similar type of device. In some implementations, server device 220 may include a communication interface that allows server device 220 to receive information from and/or transmit information to other devices in environment 200. In some implementations, server device 220 may be a physical device implemented within a housing, such as a chassis. In some implementations, server device 220 may be a virtual device implemented by one or more computer devices of a cloud computing environment or a data center.

Device management platform 230 includes one or more devices capable of performing device management functions, such as setting and managing device policies associated with client device 210. For example, device management platform 230 may configure the use of biometric identification verification at the device level (i.e., to unlock client device 210) and/or the application level (i.e., to require the applications on client device 210 to use biometric identification verification to grant access to the applications). Additionally, device management platform 230 may ensure that only authorized applications are installed and launched on client device 210.

In some implementations, as shown, device management platform 230 may be hosted in cloud computing environment 232. Notably, while implementations described herein describe device management platform 230 as being hosted in cloud computing environment 232, in some implementations, device management platform 230 may not be cloud-based (i.e., may be implemented outside of a cloud computing environment) or may be partially cloud-based.

Cloud computing environment 232 includes an environment that hosts device management platform 230. Cloud computing environment 232 may provide computation, software, data access, storage, and/or other services. As shown, cloud computing environment 232 may include a group of computing resources 234 (referred to collectively as “computing resources 234” and individually as “computing resource 234”).

Computing resource 234 includes one or more personal computers, workstation computers, server devices, or another type of computation and/or communication device. In some implementations, computing resource 234 may host device management platform 230. The cloud resources may include compute instances executing in computing resource 234, storage devices provided in computing resource 234, data transfer devices provided by computing resource 234, etc. In some implementations, computing resource 234 may communicate with other computing resources 234 via wired connections, wireless connections, or a combination of wired and wireless connections.

As further shown in FIG. 2, computing resource 234 may include a group of cloud resources, such as one or more applications (“APPs”) 234-1, one or more virtual machines (“VMs”) 234-2, one or more virtualized storages (“VSs”) 234-3, or one or more hypervisors (“HYPs”) 234-4.

Application 234-1 includes one or more software applications that may be provided to or accessed by one or more devices of environment 200. Application 234-1 may eliminate a need to install and execute the software applications on devices of environment 200. For example, application 234-1 may include software associated with device management platform 230 and/or any other software capable of being provided via cloud computing environment 232. In some implementations, one application 234-1 may send/receive information to/from one or more other applications 234-1, via virtual machine 234-2. In some implementations, application 234-1 may include a software application associated with one or more databases and/or operating systems. For example, application 234-1 may include an enterprise application, a functional application, an analytics application, and/or the like.

Virtual machine 234-2 includes a software implementation of a machine (e.g., a computer) that executes programs like a physical machine. Virtual machine 234-2 may be either a system virtual machine or a process virtual machine, depending upon use and degree of correspondence to any real machine by virtual machine 234-2. A system virtual machine may provide a complete system platform that supports execution of a complete operating system (“OS”). A process virtual machine may execute a single program, and may support a single process. In some implementations, virtual machine 234-2 may execute on behalf of a user (e.g., a user of client device 210), and may manage infrastructure of cloud computing environment 232, such as data management, synchronization, or long-duration data transfers.

Virtualized storage 234-3 includes one or more storage systems and/or one or more devices that use virtualization techniques within the storage systems or devices of computing resource 234. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 234-4 provides hardware virtualization techniques that allow multiple operating systems (e.g., “guest operating systems”) to execute concurrently on a host computer, such as computing resource 234. Hypervisor 234-4 may present a virtual operating platform to the guest operating systems, and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

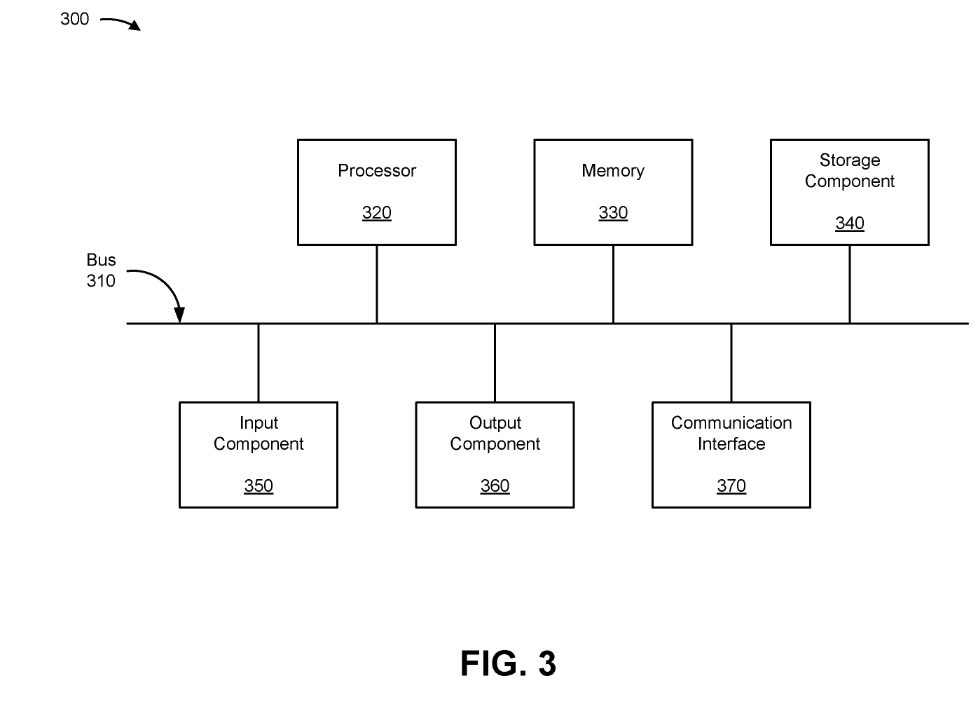

FIG. 3 is a diagram of example components of a device 300. Device 300 may correspond to client device 210, server device 220, device management platform 230, and/or computing resource 234. In some implementations, client device 210, server device 220, device management platform 230, and/or computing resource 234 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

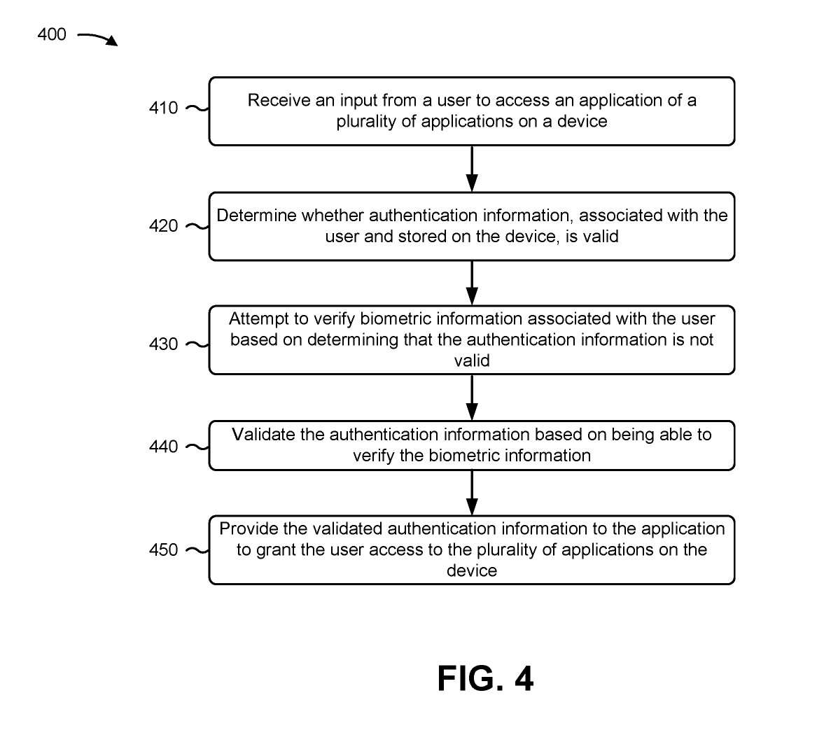

FIG. 4 is a flow chart of an example process 400 for biometric-based SSO. In some implementations, one or more process blocks of FIG. 4 may be performed by a device (e.g., client device 210). In some implementations, one or more process blocks of FIG. 4 may be performed by another device or a group of devices separate from or including client device 210, such as server device 220 and/or device management platform 230.

As shown in FIG. 4, process 400 may include receiving an input from a user to access an application of a plurality of applications on a device (block 410). For example, the device (e.g., using processor 320, memory 330, storage component 340, input component 350, and/or the like) may receive an input from a user to access an application of a plurality of applications on the device, as described above in connection with FIGS. 1A-1H.

As further shown in FIG. 4, process 400 may include determining whether authentication information, associated with the user and stored on the device, is valid (block 420). For example, the device (e.g., using processor 320, memory 330, storage component 340, communication interface 370, and/or the like) may determine whether authentication information, associated with the user and stored on the device, is valid, as described above in connection with FIGS. 1A-1H.

As further shown in FIG. 4, process 400 may include attempting to verify biometric information associated with the user based on determining that the authentication information is not valid (block 430). For example, the device (e.g., using processor 320, memory 330, storage component 340, communication interface 370, and/or the like) may attempt to verify biometric information associated with the user based on determining that the authentication information is not valid, as described above in connection with FIGS. 1A-1H. In some implementations, the biometric information may be provided as input to the device.

As further shown in FIG. 4, process 400 may include validating the authentication information based on being able to verify the biometric information (block 440). For example, the device (e.g., using processor 320, memory 330, storage component 340, communication interface 370, and/or the like) may validate the authentication information based on being able to verify the biometric information, as described above in connection with FIGS. 1A-1H.

As further shown in FIG. 4, process 400 may include providing the validated authentication information to the application to grant the user access to the plurality of applications on the device (block 450). For example, the device (e.g., using processor 320, memory 330, storage component 340, input component 350, output component 360, communication interface 370, and/or the like) may provide the validated authentication information to the application to grant the user access to the plurality of applications on the device, as described above in connection with FIGS. 1A-1H.

Process 400 can include additional implementations, such as any single implementation or any combination of implementations described below and/or described with regard to any other process described herein.

In some implementations, process 400 may include storing a validity status, for the authentication information, in a SSO data store on the device, and determining whether the authentication information is valid based on the validity status in the SSO data store. In some implementations, the validity status may be determined based on a time duration of inactivity associated with the plurality of applications.

In some implementations, the device may be configured by a device management platform to use biometric information validation, and the device may attempt to verify the biometric information associated with the user based on determining that the device is configured by the device management platform to use biometric information validation.

In some implementations, process 400 may include deleting the authentication information from the device based on being unable to verify the biometric information, and requesting the user to input login credentials after deleting the authentication information.

In some implementations, process 400 may include receiving the login credentials as input to the device, verifying the received login credentials, requesting the user to input new biometric information associated with the user based on verifying the received login credentials, and receiving the new biometric information as input to the device.

In some implementations, process 400 may include verifying the new biometric information after receiving the new biometric information as input to the device, generating new authentication information associated with the user based on verifying the new biometric information, storing the new authentication information in a secure data store on the device, setting a validity status for the new authentication information to valid, and storing the validity status for the new authentication information in a SSO data store on the device.

In some implementations, process 400 may include receiving an input from the user to access a second application on the device, determining that the validated authentication information is still valid, attempt, based on determining that the authentication information is still valid, to verify the biometric information associated with the user, and providing, based on being able to verify the biometric information, the validated authentication information to the second application to grant the user access to the second application on the device without verifying the biometric information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

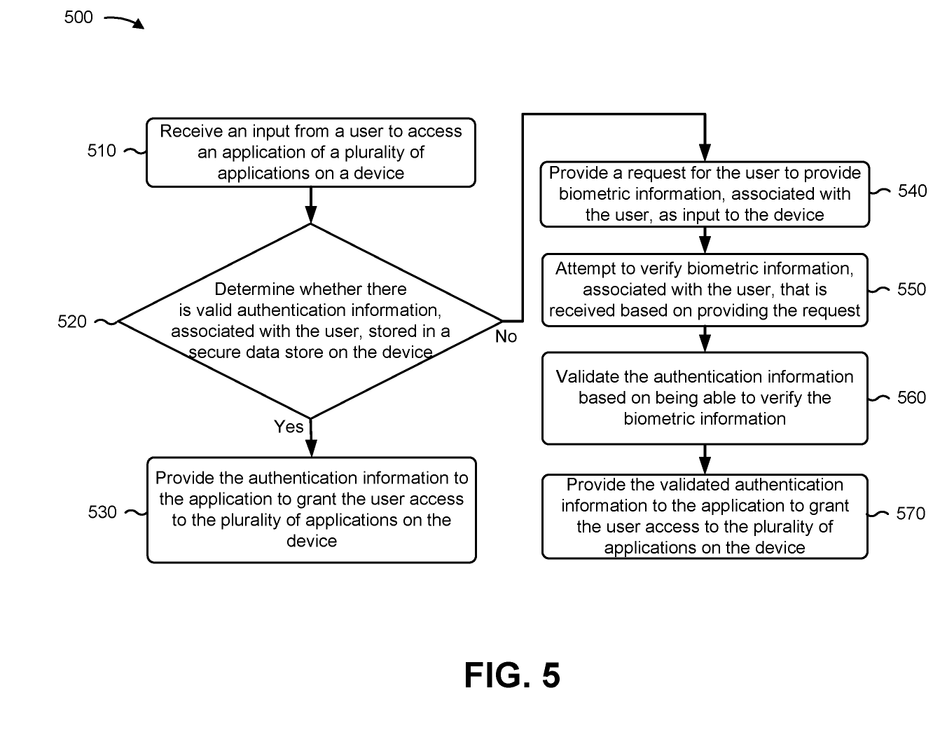

FIG. 5 is a flow chart of an example process 500 for biometric-based SSO. In some implementations, one or more process blocks of FIG. 5 may be performed by a device (e.g., client device 210). In some implementations, one or more process blocks of FIG. 5 may be performed by another device or a group of devices separate from or including client device 210, such as server device 220 and/or device management platform 230.

As shown in FIG. 5, process 500 may include receiving an input from a user to access an application of a plurality of applications on a device (block 510). For example, the device (e.g., using processor 320, memory 330, storage component 340, input component 350, and/or the like) may receive an input from a user to access an application of a plurality of applications on the device, as described above in connection with FIGS. 1A-1H.

As further shown in FIG. 5, process 500 may include determining whether authentication information, associated with the user and stored on the device, is valid (block 520). For example, the device (e.g., using processor 320, memory 330, storage component 340, communication interface 370, and/or the like) may determine whether there is valid authentication information, associated with the user, stored in a secure data store on the device, as described above in connection with FIGS. 1A-1H.

As further shown in FIG. 5, if the authentication information is determined to be valid, process 500 may include providing the authentication information to the application to grant the user access to the plurality of applications on the device (block 530). For example, the device (e.g., using processor 320, memory 330, storage component 340, input component 350, output component 360, and/or the like) may provide the authentication information to the application to grant the user access to the plurality of applications on the device, as described above in connection with FIGS. 1A-1H.

As further shown in FIG. 5, if the authentication information is determined to be not valid, process 500 may include providing a request for the user to provide biometric information associated with the user as input to the device (block 540). For example, the device (e.g., using processor 320, memory 330, storage component 340, input component 350, output component 360, and/or the like) may provide a request for the user to provide biometric information associated with the user as input to the device, as described above in connection with FIGS. 1A-1H.

As further shown in FIG. 5, process 500 may include attempting to verify biometric information, associated with the user, received based on providing the request (block 550). For example, the device (e.g., using processor 320, memory 330, storage component 340, communication interface 370, and/or the like) may attempt to verify biometric information, associated with the user, received based on providing the request, as described above in connection with FIGS. 1A-1H.

As further shown in FIG. 5, process 500 may include validating the authentication information based on being able to verify the biometric information (block 560). For example, the device (e.g., using processor 320, memory 330, storage component 340, communication interface 370, and/or the like) may validate the authentication information based on being able to verify the biometric information, as described above in connection with FIGS. 1A-1H.

As further shown in FIG. 5, process 500 may include providing the validated authentication information to the application to grant the user access to the plurality of applications on the device (block 570). For example, the device (e.g., using processor 320, memory 330, storage component 340, input component 350, output component 360, and/or the like) may provide the validated authentication information to the application to grant the user access to the plurality of applications on the device, as described above in connection with FIGS. 1A-1H.

Process 500 can include additional implementations, such as any single implementation or any combination of implementations described below and/or described with regard to any other process described herein.

In some implementations, determining whether there is valid authentication information, associated with the user, stored in a secure data store on the device may include determining, based on metadata stored in a SSO data store, whether there is valid authentication information, associated with the user, stored in a secure data store.

In some implementations, process 500 may include deleting the authentication information stored in the secure data store based on being unable to verify the biometric information, requesting the user to input login credentials after deleting the authentication information, receiving the login credentials as input to the device based on the request for the user to provide the login credentials, verifying the received login credentials, requesting the user to input new biometric information associated with the user based on verifying the received login credentials, and receiving the new biometric information as input to the device.

In some implementations, process 500 may include verifying the new biometric information after receiving the new biometric information as input to the device, generating new authentication information associated with the user based on verifying the new biometric information, and storing the new authentication information in the secure data store on the device.

In some implementations, process 500 may include setting a validity status for the new authentication information to valid in a SSO data store on the device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

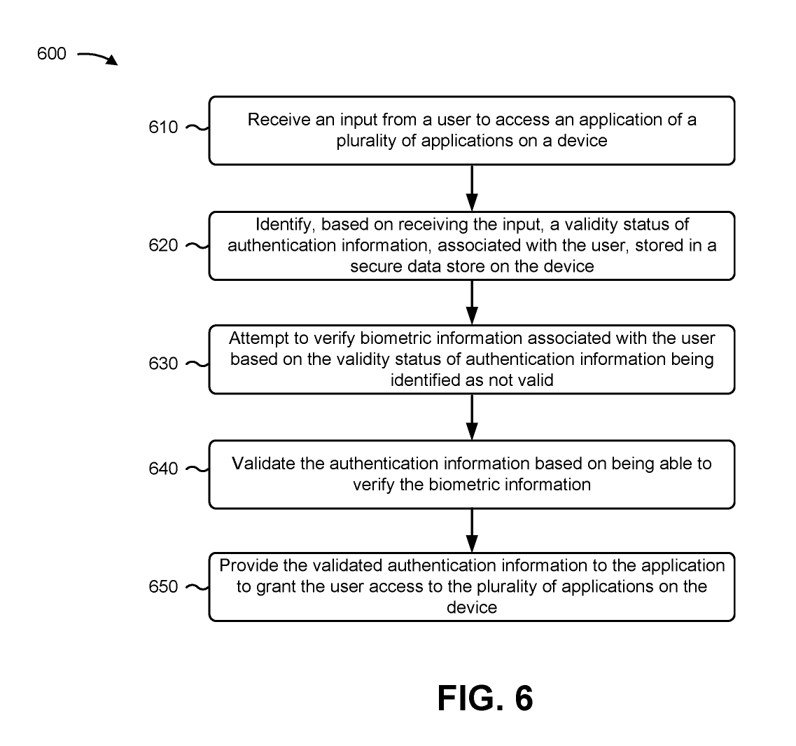

FIG. 6 is a flow chart of an example process 600 for biometric-based SSO. In some implementations, one or more process blocks of FIG. 6 may be performed by a device (e.g., client device 210). In some implementations, one or more process blocks of FIG. 6 may be performed by another device or a group of devices separate from or including client device 210, such as server device 220 and/or device management platform 230.

As shown in FIG. 6, process 600 may include receiving an input from a user to access an application of a plurality of applications on a device (block 610). For example, the device (e.g., using processor 320, memory 330, storage component 340, input component 350, and/or the like) may receive an input from a user to access an application of a plurality of applications on the device, as described above in connection with FIGS. 1A-1H.

As further shown in FIG. 6, process 600 may include identifying, based on receiving the input, a validity status of authentication information, associated with the user, stored in a secure data store on the device (block 620). For example, the device (e.g., using processor 320, memory 330, storage component 340, communication interface 370, and/or the like) may identify, based on receiving the input, a validity status of authentication information, associated with the user, stored in a secure data store on the device, as described above in connection with FIGS. 1A-1H. In some implementations, the validity status of the authentication information may be based on a time duration of inactivity associated with the plurality of applications. In some implementations, the validity status of the authentication information may be stored in a SSO data store on the device.

As further shown in FIG. 6, process 600 may include attempting to verify biometric information associated with the user based on the validity status of authentication information being identified as not valid (block 630). For example, the device (e.g., using processor 320, memory 330, storage component 340, communication interface 370, and/or the like) may attempt to verify biometric information associated with the user based on the validity status of authentication information being identified as not valid, as described above in connection with FIGS. 1A-1H. In some implementations, the biometric information may be provided as input to the device.

As further shown in FIG. 6, process 600 may include validating the authentication information based on being able to verify the biometric information (block 640). For example, the device (e.g., using processor 320, memory 330, storage component 340, communication interface 370, and/or the like) may validate the authentication information based on being able to verify the biometric information, as described above in connection with FIGS. 1A-1H.

As further shown in FIG. 6, process 600 may include providing the validated authentication information to the application to grant the user access to the plurality of applications on the device (block 650). For example, the device (e.g., using processor 320, memory 330, storage component 340, input component 350, output component 360, and/or the like) may provide the validated authentication information to the application to grant the user access to the plurality of applications on the device, as described above in connection with FIGS. 1A-1H.

Process 600 can include additional implementations, such as any single implementation or any combination of implementations described below and/or described with regard to any other process described herein.

In some implementations, process 600 may include setting the validity status of the authentication information by comparing the time duration of inactivity associated with the plurality of applications and a threshold time duration of inactivity, and setting the validity status of the authentication information based on a result of the comparison.

In some implementations, setting the validity status of the authentication information based on the result of the comparison may include setting the validity status of the authentication information to not valid based on the time duration of inactivity associated with the plurality of applications satisfying the threshold time duration of inactivity, or setting the validity status of the authentication information to valid based on the time duration of inactivity associated with the plurality of applications not satisfying the threshold time duration of inactivity.

In some implementations, each of the plurality of applications may be associated with a respective time duration of inactivity, and the validity status of the authentication information may further be based on the respective time durations of inactivity of the plurality of applications.

In some implementations, process 600 may include setting the validity status of the authentication information associated with the user by comparing the respective time durations of inactivity of the plurality of applications and a threshold time duration of inactivity, and setting the validity status of the authentication information associated with the user based on a result of the comparison.

In some implementations, setting the validity status of the authentication information based on the result of the comparison may include setting the validity status of the authentication information to not valid based on all of the respective time durations of inactivity of the plurality of applications satisfying the threshold time duration of inactivity, or setting the validity status of the authentication information to valid based on any of the respective time durations of inactivity of the plurality of applications not satisfying the threshold time duration of inactivity.

In some implementations, the validity status of the authentication information associated with the user may be stored as metadata in the SSO data store on the device. In some implementations, the metadata in the SSO data store may further include at least one of information identifying a time the authentication information associated with the user was generated or information identifying a time the authentication information associated with the user was last accessed.

In some implementations, process 600 may include setting the validity status of the authentication information to not valid based on determining that the user logged out of one or more applications of the plurality of applications.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive an input from a user to access an application of a plurality of applications on the device;
determine whether authentication information, associated with the user and stored on the device, is valid;
attempt to verify biometric information associated with the user based on determining that the authentication information is not valid,
wherein the biometric information is provided as input to the device;
validate the authentication information based on being able to verify the biometric information; and
provide the validated authentication information to the application to grant the user access to the plurality of applications on the device.

2. The device of claim 1, wherein the one or more processors are further to:
store a validity status, for the authentication information, in a single sign-on (SSO) data store on the device,
wherein the validity status is determined based on a time duration of inactivity associated with the plurality of applications; and
determine whether the authentication information is valid based on the validity status in the SSO data store.

3. The device of claim 1, wherein the device is configured by a device management platform to use biometric information validation, and the one or more processors, when attempting to verify biometric information associated with the user, are to:
attempt to verify the biometric information associated with the user based on determining that the device is configured by the device management platform to use biometric information validation.

4. The device of claim 1, wherein the one or more processors are further to:
delete the authentication information from the device based on being unable to verify the biometric information; and
request the user to input login credentials after deleting the authentication information.

5. The device of claim 4, wherein the one or more processors are further to:
receive the login credentials as input to the device;
verify the received login credentials;
request the user to input new biometric information associated with the user based on verifying the received login credentials; and
receive the new biometric information as input to the device.

6. The device of claim 5, wherein the one or more processors are further to:
verify the new biometric information after receiving the new biometric information as input to the device;
generate new authentication information associated with the user based on verifying the new biometric information;
store the new authentication information in a secure data store on the device;
set a validity status for the new authentication information to valid; and
store the validity status, for the new authentication information, in a single sign-on (SSO) data store on the device.

7. The device of claim 1, wherein the one or more processors are further to:
receive an input from the user to access a second application on the device;
determine that the validated authentication information is still valid;
attempt, based on determining that the authentication information is still valid, to verify the biometric information associated with the user; and
provide, based on being able to verify the biometric information, the validated authentication information to the second application to grant the user access to the.

8. A method, comprising:
receiving, by a device, an input from a user to access an application of a plurality of applications on the device;
determining, by the device and based on receiving the input, whether there is valid authentication information, associated with the user, stored in a secure data store on the device;
if the authentication information is determined to be valid, providing, by the device, the authentication information to the application to grant the user access to the plurality of applications on the device; or
if the authentication information is determined to be not valid:
providing, by the device, a request for the user to provide biometric information associated with the user as input to the device;
attempting, by the device, to verify biometric information, associated with the user, received based on providing the request;
validating, by the device, the authentication information based on being able to verify the biometric information; and
providing, by the device, the validated authentication information to the application to grant the user access to the plurality of applications on the device.

9. The method of claim 8, wherein determining whether there is valid authentication information, associated with the user, stored in the secure data store on the device comprises:
determining, based on metadata stored in a single sign-on (SSO) data store, whether there is valid authentication information, associated with the user, stored in the secure data store.

10. The method of claim 8, further comprising:
deleting the authentication information stored in the secure data store based on being unable to verify the biometric information;
requesting the user to input login credentials after deleting the authentication information;
receiving the login credentials as input to the device based on the request for the user to provide the login credentials;
verifying the received login credentials;
requesting the user to input new biometric information associated with the user based on verifying the received login credentials; and
receiving the new biometric information as input to the device.

11. The method of claim 10, further comprising:
verifying the new biometric information after receiving the new biometric information as input to the device;
generating new authentication information associated with the user based on verifying the new biometric information; and
storing the new authentication information in the secure data store on the device.

12. The method of claim 11, further comprising:
setting a validity status for the new authentication information to valid in a single sign-on (SSO) data store on the device.

13. A non-transitory computer-readable medium storing instructions, the instructions comprising:
one or more instructions that, when executed by one or more processors, cause the one or more processors to:
receive an input from a user to access an application of a plurality of applications on a device;
identify, based on receiving the input, a validity status of authentication information, associated with the user, stored in a secure data store on the device,
wherein the validity status of the authentication information is based on a time duration of inactivity associated with the plurality of applications, and
wherein the validity status of the authentication information is stored in a single sign-on (SSO) data store on the device;
attempt to verify biometric information associated with the user based on the validity status of authentication information being identified as not valid,
wherein the biometric information is provided as input to the device;
validate the authentication information based on being able to verify the biometric information; and
provide the validated authentication information to the application to grant the user access to the plurality of applications on the device.

14. The non-transitory computer-readable medium of claim 13, wherein the one or more instructions, when executed by the one or more processors, further cause the one or more processors to:
set the validity status of the authentication information by comparing the time duration of inactivity associated with the plurality of applications and a threshold time duration of inactivity, and setting the validity status of the authentication information based on a result of the comparison.

15. The non-transitory computer-readable medium of claim 14, wherein the one or more instructions, that cause the one or more processors to set the validity status of the authentication information based on the result of the comparison, cause the one or more processors to:
set the validity status of the authentication information to not valid based on the time duration of inactivity associated with the plurality of applications satisfying the threshold time duration of inactivity; or
set the validity status of the authentication information to valid based on the time duration of inactivity associated with the plurality of applications not satisfying the threshold time duration of inactivity.

16. The non-transitory computer-readable medium of claim 13, wherein:
each of the plurality of applications is associated with a respective time duration of inactivity; and
the validity status of the authentication information is further based on the respective time durations of inactivity of the plurality of applications.

17. The non-transitory computer-readable medium of claim 16, wherein the one or more instructions, when executed by the one or more processors, further cause the one or more processors to:
set the validity status of the authentication information associated with the user by comparing the respective time durations of inactivity of the plurality of applications and a threshold time duration of inactivity, and setting the validity status of the authentication information associated with the user based on a result of the comparison.

18. The non-transitory computer-readable medium of claim 17, wherein the one or more instructions, that cause the one or more processors to set the validity status of the authentication information based on the result of the comparison, cause the one or more processors to:
set the validity status of the authentication information to not valid based on all of the respective time durations of inactivity of the plurality of applications satisfying the threshold time duration of inactivity; or
set the validity status of the authentication information to valid based on any of the respective time durations of inactivity of the plurality of applications not satisfying the threshold time duration of inactivity.

19. The non-transitory computer-readable medium of claim 13, wherein:
the validity status of the authentication information associated with the user is stored as metadata in the SSO data store on the device; and
the metadata in the SSO data store further includes at least one of information identifying a time the authentication information associated with the user was generated or information identifying a time the authentication information associated with the user was last accessed.

20. The non-transitory computer-readable medium of claim 13, wherein the one or more instructions, when executed by the one or more processors, further cause the one or more processors to:
set the validity status of the authentication information to not valid based on determining that the user logged out of one or more applications of the plurality of applications.
